(19) United States
(12) Patent Application Publication
(10) Pub. No.: US 2019/0031344 A1
(43) Pub. Date: Jan. 31, 2019

(54) UTILISING UAVS FOR DETECTING DEFECTS IN SOLAR PANEL ARRAYS

(71) Applicant: ABOVE SURVEYING LTD, Colchester, Essex (GB)

(72) Inventor: William John HITCHCOCK, Colchester, Essex (GB)

(21) Appl. No.: 16/070,081

(22) PCT Filed: Jan. 23, 2017
(86) PCT No.: PCT/GB2017/050168

§ 371 Date: Jul. 13, 2018

(30) Foreign Application Priority Data
Jan. 25, 2016 (GB) 1601303.9
Apr. 20, 2016 (GB) 1606891.8

(51) Int. Cl. B64C 39/02; B64D 47/08

(52) U.S. Cl. CPC B64C 39/024; B64D 47/08; B64C 2201/146; B64C 2201/123; B64C 2201/127; B64C 2201/027

(57) ABSTRACT

A method and apparatus are provided for detecting defects in a solar panel array (20), using an unmanned aerial vehicle (UAV) (10). The UAV (10) has mounted thereon a pyranometer (12), a GPS receiver (13), a thermographic camera (14), a visual imaging camera (15) and a data logger (16). The method comprises the steps of:
(i) mapping the location of panels (22) in a solar array (20);
(ii) utilising mapped data collected in step (i) to generate an optimal waypoint flight path (24) for the UAV (10);
(iii) transmitting the optimal waypoint flight path data (24) generated in step (ii) to the control means of the UAV (10);
(iv) flying the UAV (10) over the solar array (20) using the optimal waypoint flight path (24), whilst simultaneously recording thermographic and visual imagery, and logging solar irradiance and GPS data; and
(v) processing data logged in step (iv) to identify and report defective panels (22) by temperature gradient, with cross-referenced solar irradiance data, thermographic and visual imagery and GPS location data.

This invention relates, in a first aspect thereof, to an unmanned aerial vehicle (UAV), modified for use in detecting and assessing defects in solar panel arrays. In a second aspect thereof, the invention further relates to apparatus for detecting and assessing defects in solar panel arrays, including such a modified UAV. In a third aspect thereof, the invention further relates to a method for detecting and assessing defects in solar panel arrays, utilising such apparatus.

The present invention is primarily concerned with the detection and assessment of defective solar panels in large-scale solar array installations, such as solar farms, and will therefore be described herein with particular emphasis on this application. It will be appreciated however that the scope of the present invention is not limited to such use, and all aspects of the invention may find use in other applications.

A defect in a solar panel presents as a ‘hotspot’, i.e. a mismatch between the surface temperature of the defective panel, compared to adjacent normally functioning panels. This mismatch is measurable as a temperature gradient, through the use of a thermographic camera. The observed temperature gradient can occur either across a panel, or within a panel in single or multiple cells. Until very recently, the standard method of inspecting a solar farm for defective panels was to use a hand-held thermographic camera. In view of the scale of solar farms, this method is time consuming and labour intensive. Moreover, the results produced by such methods have been found to be inaccurate and inconsistent.

More recently, unmanned aerial vehicles (UAVs)—also referred to as drones—are now being used to carry out thermographic inspections of large solar arrays. The use of a UAV-mounted thermographic camera with georeferenced images can significantly speed up the process as well as increasing the accuracy of the recording of the defective solar panel location.

The extent of the temperature gradient presented by a defective solar panel is often an indication of the nature and significance of the defect, its impact on electricity generation and its likelihood of degrading further. However, the temperature gradient is also a function of the solar irradiance to which the solar panel was exposed at the time of measurement. Solar irradiance changes constantly throughout daylight hours—and more importantly, varies significantly between sunny and cloudy conditions. A single cloud shading a section of a solar array can cause a significant drop in solar irradiance.

As such, in order for temperature gradient data collected during a solar panel inspection to be properly interpreted, it is important to understand the level of solar irradiance at the precise time and location when the thermographic image was captured. Reliable time- and location-specific solar irradiance data, measurable with a pyranometer, is therefore of high value when reviewing the inspection data and deciding on remedial action in respect to an apparently defective solar panel.

Until now, thermographic imaging data collected during a solar panel array inspection has been cross-referenced with solar irradiance data measured via a static, ground-based pyranometer. However, this method does not take account of variations in solar irradiance during the inspection process or across the length and width of the array. This can again lead to inaccurate, inconsistent and unreliable results.

There are a range of different possible defects in solar panels, which may present as a temperature gradient across the panel. These include physical damage to panels, soiling of the panel surface, electrical connection faults, and degenerative defects. Degenerative defects are difficult to detect in their early stages by conventional means, but if left unchecked can cause major problems for solar installations.

One example of such a degenerative defect is a phenomenon known as Potential Induced Degradation (PID). PID is an inherent defect which arises in some solar panels (also referred to as modules), and occurs when the potential (voltage) causes ion mobility in the module's semi-conductor material. This causes the module's power output capacity to degrade. PID presents a major problem for solar farm operators, since in its early stages it is difficult to detect via conventional methods, but if left unchecked it can spread from one module to another in an array. Modules in a solar array are typically arranged in “strings” of 24 modules connected in series. PID generally initiates at the negative end of such a string, but can then spread through the modules in the string.

The present invention seeks to address the above issues by mounting a custom-made geo-referencing pyranometer onto a UAV, so that solar irradiance can be measured during flight, and the time and GPS co-ordinates of each measurement can be logged. It will therefore now be possible for thermographic images to be cross-referenced with corresponding solar irradiance data. This will enable more informed analysis of the apparently defective panel, and will inform consideration of possible remedial action, or further diagnostics. A major benefit of the present invention is that it enables early detection and analysis of degenerative defects such as Potential Induced Degradation (PID). Defective modules can then be repaired or replaced.

According to a first aspect of the present invention there is provided an unmanned aerial vehicle (UAV) having remotely controllable and/or programmable control means, thereby to direct said UAV's flight path, said UAV having the following components mounted thereon:
a thermographic camera;
a pyranometer;
a global positioning system (GPS) receiver; and
a data logger, adapted to log data from at least the pyranometer and the GPS receiver during flight of said UAV.

The UAV of the present invention preferably further has a visual imaging camera mounted thereon.

The pyranometer and the GPS receiver together effectively form a geo-referencing pyranometer. By using the pyranometer to record the solar irradiance at the precise time and location where temperature gradients are observed, the UAV operator or post-flight analyst can identify variations in reported temperature gradients which may be attributable to fluctuations in the solar irradiance, rather than the severity of a defect in a panel or cell.

The unmanned aerial vehicle (UAV) is preferably a rotary wing UAV.

As noted above, the UAV preferably has a visual (RGB) imaging camera mounted thereon. The use of a visual (RGB) imaging camera is desirable in order to carry out preferred embodiments of the method for which the UAV according to the first aspect of the present invention is intended. However, whilst it is preferred that the visual imaging camera should be mounted on the same UAV as the other components, as an alternative arrangement, a second UAV may be employed, on which said visual imaging camera is provided. This alternative arrangement enables the overall weight of the UAV of the present invention to be reduced, and this in turn improves battery life on the UAV and thus lengthens possible flight time.

In preferred embodiments in which the thermographic and visual imaging cameras are mounted on the UAV of the invention, the UAV can record and report both thermographic and visual images, which can be cross-referenced with the temperature gradient data, solar irradiance data, and GPS data for any location in a solar array. The visual and thermographic imagery is preferably provided to the UAV operator for viewing during flight via a live video link. In the alternative arrangement in which the visual imaging camera is provided on a second UAV, these processes are still carried out, using the RGB imaging data from the flight of the second UAV, which may be carried out either before, after, or preferably simultaneously with the flight of the UAV of the invention.

Providing visual imagery of the panels assists in identifying the physical location of panels reporting defects, and also enables the UAV operator or post-flight analyst to characterise the defect by cross-referencing the visual and thermographic imagery. The analyst can use the visual imagery data to observe physical damage or obstructions on the surface of panels. Obstructions, such as dirt present on the surface of panels can lead to variations in reported temperature gradient data which might otherwise be attributed to the severity of a defect. In this way, the analyst can also identify defects which might be attributable to degenerative defects such as PID.

The thermographic camera and/or the visual imaging camera preferably have geo-referencing functionality, which further assists with the above described assessment of defects. The thermographic camera and/or the visual imaging camera may log their GPS data to a local memory card, such as an SD card. This data can then be cross-referenced post-flight with the logged solar irradiance data.

In a preferred embodiment of the invention, the data logger is further adapted to communicate logged data to a remote device during flight. This enables the ‘live’ viewing of data whilst an inspection is taking place. To this end, the data logger is preferably adapted to communicate the logged data over a mobile telecommunications network via a GSM standard signal.

In a further preferred embodiment of the invention, the data logger is further adapted to log data from the thermographic camera, and/or the visual imaging camera, when present, in addition to the pyranometer and the GPS receiver.

Alternatively, or additionally, the data logger may preferably be or comprise an embedded computer, or an embedded computer may be provided as a further component, in communication with said data logger. The embedded computer is preferably adapted to store all the generated data sets from the other components, and more preferably is further adapted at least partially to process said data on the UAV.

The pyranometer is preferably a light-weight pyranometer. Most preferably, the combined mass of the pyranometer, the GPS receiver, and the data logger is no more than 1 kg. The pyranometer may be any sensor capable of measuring solar irradiance, such as a reference cell. In preferred embodiments of the invention however, the pyranometer is a silicon cell pyranometer.

As will be appreciated, the communication of data to and from the UAV is an important facet of the inspection process. Therefore, according to a second aspect of the present invention there is provided apparatus for detecting and assessing defects in solar panel arrays, said apparatus comprising an unmanned aerial vehicle (UAV) as hereinbefore described, and one or more remote devices in communication therewith. In the alternative arrangement in which the UAV does not comprise a visual imaging camera, the apparatus according to the second aspect of the present invention will further comprise a second UAV having a visual imaging camera mounted thereon.

Preferably, said apparatus comprises a remote device, such as a PC, laptop, tablet computer or smartphone, adapted to receive data from said data logger. Most preferably, said remote device is further adapted to receive data from said thermographic camera and/or said visual imaging camera.

The remote device preferably comprises a processor adapted to process said data and to report cross-referenced thermographic data and solar irradiance data for a given GPS-referenced location in a solar panel array. Most preferably, the remote device is further adapted to process and report visual imaging data for a given GPS-referenced location.

In preferred embodiments of the present invention, the remote device is further adapted to process recorded solar irradiance data, in order to correct for the angle of tilt of the solar panels in an array. The processor of the remote device is therefore preferably programmed with an algorithm developed to correct a measured irradiance (Eₘ) collected in the horizontal plane, to a corrected irradiance (E_{c}) to allow for the angle of tilt of solar panels in an array.

The above described processing is required because irradiance data is collected in the horizontal plane by the UAV. This must therefore be corrected in order to calculate the irradiance to which the angled surface of the solar panel is exposed. An alternative approach would be to tilt the pyranometer to match the angle of tilt of the solar panels in an array, before each survey is carried out.

The remote device is preferably further adapted also to process recorded thermographic data, in order to normalise the data to a standard level of irradiance. The processor of the remote device is therefore preferably programmed with an algorithm developed to normalise a recorded measured temperature gradient (ΔTₘ) at a corrected irradiance (E_{c}), to a normalised temperature gradient (ΔTₙ) at a standard irradiance. Whilst in theory, any value of standard irradiance could be used, it is preferred to use a standard irradiance value of 1000 W/m².

The thermal gradient measured across a defect in a solar panel is a function of the severity of the defect and the solar irradiance to which the defective solar panel was subjected at the time of the thermal gradient being measured. Normalising the temperature gradient data to a standard irradiance level therefore enables the comparison of defects within a survey, or across different surveys.

Processing the irradiance and thermographic data in this way enables defects to be categorised in terms of their nature, severity, and prognosis for further deterioration. The processing also enables direct comparison of inspections carried out at different irradiance levels, as for example would occur at different times of year, so that the level of deterioration of a defective panel can be monitored.

The apparatus may desirably comprise a remote device adapted to transmit pre-determined flight path data to the UAV's control means. This remote device may be the same device as is adapted to receive data from the data logger, or may be a separate remote device.

The remote device to which the logged data is communicated may take the form of an online, web-based portal. All data recorded, together with any subsequent analysis carried out by the UAV operator or post-flight analyst, may be displayed on the portal. The user (usually the solar farm owner, manager or operator) may then access the portal via a personalised login, in order to view all data associated with a particular inspection. The data may desirably include a zoomable map, in which the data logged and processed from the inspection is overlayered onto an existing map of the solar panels in an inspected array—such as a CAD drawing of the solar farm. The user can thus clearly identify the location of defective panels.

The portal may display data relating to a number of different inspections of the same solar array carried out at different times. By utilising the normalised thermal gradient data, which takes into account variations in the incident solar irradiance at the time of the inspection, the user may thus make a comparison between data collected at different times and in different conditions. This enables the user to ascertain whether a particular defect has improved (for example following maintenance or repair) or deteriorated. Such comparisons can also assist the user in determining whether defects have been correctly characterised.

Where defects are attributable to degenerative defects such as PID, the plotting of the location of defective modules on the map can assist the user in understanding the factors that may be promoting the occurrence of the defect. For example, PID may be observed in modules at a particular location on a site, or in modules of a certain age, or in modules originating from a particular manufacturer, supplier or batch. By looking for such trends in the occurrence of PID, the user can predict where future occurrences of PID may arise, and monitor those locations more closely in order to catch PID as soon as it occurs, and so prevent its spread along a string.

The present invention further provides, according to a third aspect thereof, a method for detecting and assessing defects in a solar panel array, using an unmanned aerial vehicle (UAV) as hereinbefore described, said method comprising performing the steps of:

(i) mapping the location of panels in a solar array;

(ii) utilising mapped data collected in step (i) to generate an optimal waypoint flight path for said UAV;

(iii) transmitting the optimal waypoint flight path data generated in step (ii) to the control means of said UAV; and

(iv) flying said UAV over said solar array using said optimal waypoint flight path, whilst simultaneously recording at least thermographic imaging data and logging solar irradiance and GPS data;

and subsequently:

(v) processing data recorded and logged in step (iv to identify and report defective panels by temperature gradient, with cross-referenced solar irradiance data, thermographic imagery and GPS location data.

In preferred embodiments of the above method in which the UAV has a visual imaging camera mounted thereon, visual imaging data will also be recorded in step (iv), and the data processed in step (v) will also include cross-referenced visual imagery data from step (iv).

In the alternative arrangement in which the UAV does not have a visual imaging camera mounted thereon, the method will include an additional sub-step of:

(iv)(a) flying a second UAV having a visual imaging camera mounted thereon, over said solar array using said optimal waypoint flight path, whilst simultaneously recording visual imaging data. In this alternative arrangement, step (v) will necessarily require the data recorded in sub-step (iv)(a) to be compiled and processed along with the data recorded and logged in step (iv). Sub-step (iv)(a) may be carried out either before, after, or preferably simultaneously with the performance of step (iv).

In practice, the step (i) of mapping the location of panels in a solar array may already have been carried out prior to the inspection process, in which case the mapped data may already be available (for example in the form of a CAD drawing) which can be used directly to generate the optimal waypoint flight path data in step (ii).

Step (v) of the method preferably includes processing the recorded solar irradiance data, thereby to correct a measured irradiance (Eₘ) collected in the horizontal plane, to a corrected irradiance (E_{c}) to allow for the angle of tilt of solar panels in an array, as described above with reference to the second aspect of the invention.

Step (v) preferably further includes processing recorded thermographic data, thereby to normalise a recorded measured temperature gradient (ΔTₘ) at a corrected irradiance (E_{c}) to a normalised temperature gradient (ΔTₙ) at a standard irradiance of 1000 W/m², as also described above with reference to the second aspect of the invention. The solar irradiance and GPS data logged in step (iv) may preferably be transmitted to a remote device, as hereinbefore described with reference to the second aspect of the present invention. Most preferably, the thermographic and visual imaging data recorded in step (iv), or in step (iv) and sub-step (iv)(a), is also transmitted to said remote device. The processing and analysis in step (v) is preferably performed using said remote device.

The generation and transmittal of the optimum waypoint flight in steps (ii) and (iii) is preferably performed using a remote device. This may be the same remote device which receives the data from the data logger, or may be a separate remote device. Preferably, the optimal waypoint flight path data transmitted to the UAV control means in step (iii) also includes flight height and speed. The optimal flight height utilised in the method of the present invention is generally around 20 m, which is lower than conventional flight heights used in UAV inspections. This lower flight height facilitates better resolution of the thermal imaging data, which in turn assists with the detection and analysis of degenerative defects such as PID.

The method preferably further includes an additional step (vi) of transmitting the logged, processed and analysed data to a web portal as hereinbefore described with reference to the second aspect of the invention.

In order that the present invention may be more clearly understood, a preferred embodiment thereof will now be described in detail, though only by way of example, with reference to the accompanying drawings, in which:

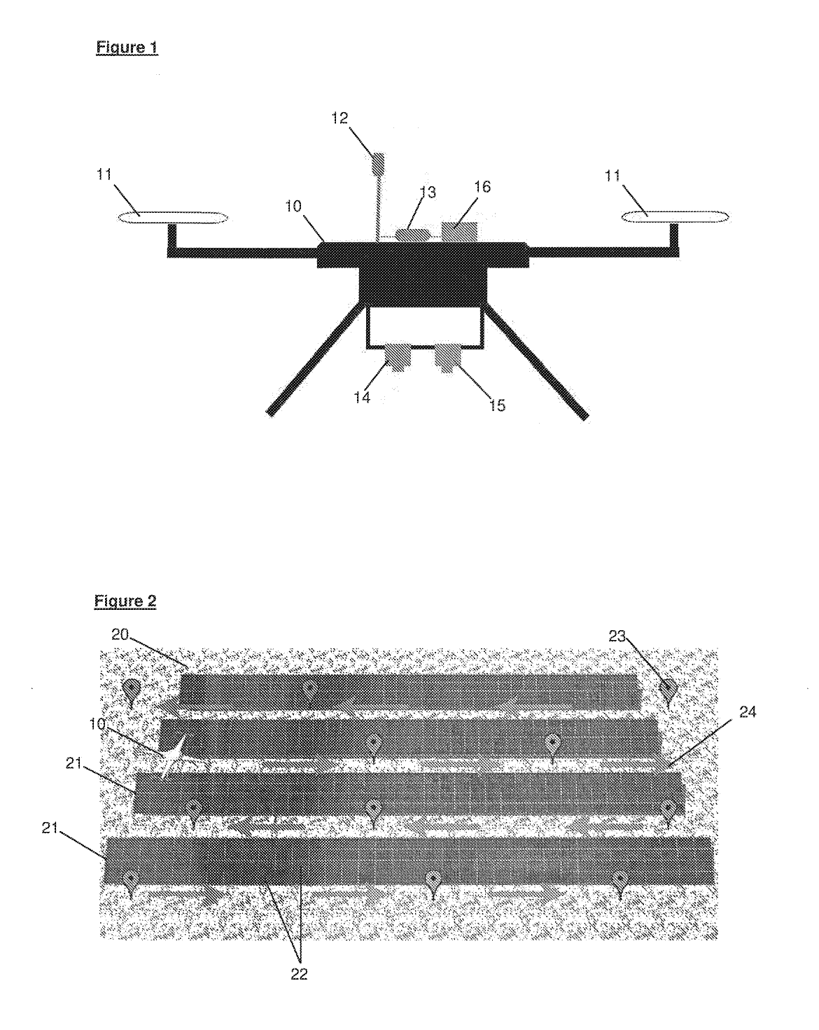

FIG. 1 shows a schematic representation of a preferred embodiment of an unmanned aerial vehicle (UAV) according to the first aspect of the present invention; and

FIG. 2 shows a schematic representation of the UAV of FIG. 1 in use, carrying out an inspection of a solar panel array.

Referring first to FIG. 1, there is shown an unmanned aerial vehicle (UAV) 10, according to a preferred embodiment of a first aspect of the present invention. As can be seen, the UAV 10 is of the rotary wing type, having a plurality of rotors 11. The UAV 10 has mounted thereon a number of instruments: a pyranometer 12 for measuring solar irradiance; a GPS receiver 13 for accurately tracking the location of the UAV 10; a thermographic camera 14 for recording thermographic data and images; a visual (RGB) camera 15 for recording visual images; and a data logger 16 for recording data from the pyranometer 12 and the GPS receiver 13. The pyranometer 12 and GPS receiver 13 together form a geo-referencing pyranometer. The thermographic camera 14 and the visual camera 15 also have geo-referencing functionality.

As hereinbefore discussed, in an alternative arrangement, the visual (RGB) camera 15 may instead be mounted on a second UAV (not shown).

The UAV 10 is provided with integral control means (not shown), which may be programmable, or remotely controllable, to direct the flight path of the UAV 10.

The data logger 16 is also adapted to transmit logged solar irradiance and GPS data to a remote device (not shown) during operation of the UAV 10, so that live data can be viewed during a solar array inspection. The thermographic camera 14 and visual camera 15, are adapted also to transmit live video data to a remote device for viewing during flight of the UAV 10.

The UAV 10 and the remote device together constitute apparatus for detecting defects in solar panel arrays, according to a second aspect of the present invention.

Referring now to FIG. 2, there is shown the UAV 10 as hereinbefore described with reference to FIG. 1, in use for the inspection of a solar panel array 20. The solar array 20 is made up of several banks 21 of panels, each bank 21 featuring multiple individual solar panels 22.

A method according to a third aspect of the present invention, for detecting defects in a solar panel array 20, using an unmanned aerial vehicle (UAV) 10, will now be described, with reference to FIGS. 1 and 2.

Step (i) of the method requires the location of the panels 22 and panel banks 21 in a solar array 20 to be mapped, or geo-referenced. In practice, this step may already have been carried out prior to the inspection process.

In step (ii), the mapped data collected in step (i) is used to generate an optimal waypoint flight path for the UAV 10. The waypoints 23 and the flight path 24 are illustrated figuratively in FIG. 2.

Step (iii) is to transmit the optimal waypoint flight path data 24 generated in step (ii) to the control means of the UAV 10. The flight path data 24 will also include flight height (altitude) and speed, which may need to be varied according to conditions at the time of carrying out the inspection.

The inspection process is then carried out in step (iv) by flying the UAV 10 over the solar array 20, using the optimal waypoint flight path 24. During flight, the thermographic camera 14 records thermographic imaging data for each panel 22, so that temperature gradients can be identified, which may indicate defective panels, or defective areas within a panel 22. At the same time, the pyranometer 12 measures the solar irradiance, whilst the GPS receiver 13 provides a cross-reference of the precise location (and thus the specific panel 22) at which the solar irradiance data was logged. The visual camera 15 also records images of the panels 22 during the inspection process. The data from the pyranometer 12, and the GPS receiver 13 is recorded by the data logger 16, whilst the thermographic camera 14 and visual camera 15 record their geo-referenced data to a local SD memory card.

The data logger 16 transmits the logged solar irradiance and GPS data via a GSM signal to a remote device for the data processing step (v). The thermographic camera 14 and visual camera 15 also transmit images to the UAV operator via a live video link. Post-flight, a report can be produced, showing cross-referenced thermographic imaging data and visual images, for any panel 22 in the array 20—identified by GPS location data—and cross-referenced with the recorded solar irradiance data at the time the thermographic data was captured.

Any defective panels in the array 20 will present a higher surface temperature than adjacent correctly functioning panels 22, and a temperature gradient can therefore be observed across the defective panel. Depending on the nature of the defect, a temperature gradient may also be observable within a panel 22, in single or multiple cells. However, temperature gradients can also vary where there is a natural fluctuation in solar irradiance during inspection. Measuring the solar irradiance (using the pyranometer 12) at the same time and location (indicated by the GPS receiver 13) as capturing thermographic data (using the thermographic camera 14) enables such naturally occurring temperature variations to be factored into the inspection results, thus increasing the accuracy and value of the defect detection process. Similarly, the recorded visual images (using the visual imaging camera 15) will indicate where observed temperature gradients may be attributable to obstructions on the surface of a panel 22, rather than to a defect.

1. An unmanned aerial vehicle (UAV) having remotely controllable and/or programmable control means, thereby to direct said UAV's flight path, said UAV having the following components mounted thereon:
a thermographic camera;
a pyranometer;
a global positioning system (GPS) receiver; and
a data logger, adapted to log data from at least the pyranometer and the GPS receiver during flight of said UAV.

2. The unmanned aerial vehicle as claimed in claim 1, further having a visual imaging camera mounted thereon.

3. The unmanned aerial vehicle as claimed in claim 2, wherein at least one of the thermographic camera and the visual imaging camera has geo-referencing functionality.

4. The unmanned aerial vehicle as claimed in claim 2, wherein the data logger is further adapted to log data from at least one of the thermographic camera and the visual imaging camera.

5. The unmanned aerial vehicle as claimed in claim 1, wherein the pyranometer and the GPS receiver together form a geo-referencing pyranometer.

6. The unmanned aerial vehicle as claimed in claim 1, wherein the data logger is further adapted to communicate logged data to a remote device during flight.

7. The unmanned aerial vehicle as claimed in claim 6, wherein the data logger is adapted to communicate said logged data over a mobile telecommunications network via a GSM standard signal.

8. (canceled)

9. (canceled)

10. (canceled)

11. Apparatus for detecting and assessing defects in solar panel arrays, said apparatus comprising an unmanned aerial vehicle (UAV) as claimed in claim 1, and at least one remote device in communication therewith.

12. (canceled)

13. Apparatus as claimed in claim 11, comprising an unmanned aerial vehicle having a visual imaging camera mounted thereon and wherein said remote device is further adapted to receive data from at least one of said thermographic camera and said visual imaging camera.

14. Apparatus as claimed in claim 13, comprising a remote device adapted to receive data from said data logger and wherein said remote device comprises a processor adapted to process said data and to report cross-referenced thermographic data and solar irradiance data for a given GPS-referenced location in a solar panel array.

15. (canceled)

16. Apparatus as claimed in claim 14, wherein said remote device is further adapted to process and report visual imaging data for a given GPS-referenced location.

17. Apparatus as claimed in claim 14, wherein said remote device is further adapted to process recorded solar irradiance data, thereby to correct a measured irradiance (Eₘ) collected in the horizontal plane, to a corrected irradiance (E_{c}) to allow for the angle of tilt of solar panels in an array.

18. Apparatus as claimed in claim 17, wherein said remote device is further adapted to process recorded thermographic data, thereby to normalise a recorded measured temperature gradient (ΔTₘ) at a corrected irradiance (E_{c}) to a normalised temperature gradient (ΔTₙ) at a standard irradiance of 1000 W/m².

19. Apparatus as claimed in claim 11, comprising a remote device adapted to transmit pre-determined flight path data to said control means.

20. A method for detecting and assessing defects in a solar panel array, using an unmanned aerial vehicle (UAV) as claimed in claim 1, said method comprising performing the steps of:
(i) mapping the location of panels in a solar array;
(ii) utilising mapped data collected in step (i) to generate an optimal waypoint flight path for said UAV;
(iii) transmitting the optimal waypoint flight path data generated in step (ii) to the control means of said UAV; and
(iv) flying said UAV over said solar array using the optimal waypoint flight path, whilst simultaneously recording at least thermographic imaging data and logging solar irradiance and GPS data
and subsequently:
(v) processing data recorded and logged in step (iv), to identify and report defective panels by temperature gradient, with cross-referenced solar irradiance data, thermographic imagery and GPS location data.

21. A method as claimed in claim 20, using an unmanned aerial vehicle having a visual imaging camera mounted thereon, wherein visual imaging data is also recorded in step (iv), and wherein the data processed in step (v) includes cross-referenced visual imagery data from step (iv).

22. A method as claimed in claim 20, wherein step (v) includes processing recorded solar irradiance data, thereby to correct a measured irradiance (Eₘ) collected in the horizontal plane, to a corrected irradiance (E_{c}) to allow for the angle of tilt of solar panels in an array.

23. A method as claimed in 22, wherein step (v) further includes processing recorded thermographic data, thereby to normalise a recorded measured temperature gradient (ΔTₘ) at a corrected irradiance (E_{c}) to a normalised temperature gradient (ΔTₙ) at a standard irradiance of 1000 W/m².

24. A method as claimed in claim 20, using apparatus comprising an unmanned aerial vehicle having a visual imaging camera mounted thereon, and one or more remote devices in communication with said unmanned aerial vehicle, wherein thermographic and visual imaging data recorded in step (iv), and solar irradiance and GPS data logged in step (iv) are transmitted to said remote device.

25. (canceled)

26. A method as claimed in claim 24, wherein the generation and transmittal of the optimum waypoint flight in steps (ii) and (iii), and the processing and analysis in step (v) are performed using said remote device.

27. (canceled)

28. (canceled)
